(19) United States
(12) Patent Application Publication
(10) Pub. No.: US 2024/0186536 A1
(43) Pub. Date: Jun. 6, 2024

(54) BIPOLAR PLATE FOR A FUEL CELL STACK OR AN ELECTROLYZER STACK

(71) Applicant: L'Air Liquide, Societe Anonyme pour l'Etude et l’Exploitation des Procedes Georges Claude, Paris (FR)

(72) Inventors: Johan ANDRE, Sassenage (FR); Denis SIRAC, Sassenage (FR)

(73) Assignee: L'Air Liquide, Societe Anonyme pour l'Etude et l’Exploitation des Procedes Georges Claude, Paris (FR)

(21) Appl. No.: 18/286,002

(22) PCT Filed: Apr. 8, 2021
(86) PCT No.: PCT/EP2022/055472

§ 371 Date: Oct. 6, 2023

(30) Foreign Application Priority Data
Apr. 8, 2021 (FR) FR2103579

(51) Int. Cl. H01M 8/0247; H01M 8/0267; H01M 8/0297; H01M 8/2465

(52) U.S. Cl. CPC H01M 8/0247; H01M 8/0267; H01M 8/0297; H01M 8/2465

(57) ABSTRACT

The invention relates to a bipolar plate for a fuel cell stack or an electrolyzer stack, which bipolar plate comprises an anode plate and a cathode plate assembled to each other, facing each other, the face of the anode plate opposite the face of the cathode plate defining an internal space forming a circuit for distributing a first fluid, the anode plate and the cathode plate having distinct dimensions such that at least a portion of the peripheral end of the anode plate and at least a portion of the peripheral end of the cathode plate are offset relative to each other in the plane of the bipolar plate, forming a shoulder at a peripheral end of the bipolar plate.

### CROSS REFERENCE TO RELATED APPLICATIONS

This application is a § 371 of International PCT Application PCT/EP2022/055472, filed Mar. 3, 2022, which claims the benefit of FR2103579, filed Apr. 8, 2021, both of which are herein incorporated by reference in their entireties.

### FIELD OF THE INVENTION

The present invention relates to a bipolar plate for a fuel cell stack or for an electrolyzer stack, to a cell for a fuel cell stack or electrolyzer having such a plate, and to a fuel cell stack or an electrolyzer having such a cell.

### BACKGROUND OF THE INVENTION

In a manner known per se, a fuel cell stack is an electrochemical device that makes it possible to convert chemical energy into electrical energy using a fuel, generally dihydrogen, and an oxidant, generally dioxygen or a gas containing it, such as air, the product of the reaction being water together with a release of heat and generation of electricity.

An electrolyzer is based on the reverse principle, specifically the input of electrical energy to generate chemical reactions, for example to produce a fuel such as dihydrogen and an oxidant such as oxygen. The following description more particularly concerns the fuel cell stack, but could be applied to the electrolyzer.

A fuel cell stack or an electrolyzer is a stack of multiple cells, each cell having two bipolar plates that sandwich a membrane electrode assembly (MEA). The components of a stack of cells are aligned, when each bipolar plate is being added to the stack, either from the inside, by means of guides disposed in the openings in the bipolar plates (either dedicated openings or by utilizing one or more collectors), or from the outside, by means of at least three guide pins that come into contact with respective edges of the bipolar plate.

The alignment of the components of a stack of several tens of cells or even several hundred cells is tricky. The various components of the stack (notably the bipolar plates and the MEA) can specifically tend to slide on one another, thus causing an aesthetic defect, a loss in performance, a leak and reduced resistance to vibrations. A poor alignment of the bipolar plates and of the MEA can also increase the risk of a short circuit. The risk is all the greater if there is a short distance, even locally, between two points of different potentials and if a conductor element fills this space (metal chips, dust, etc.)

During the manufacture of a fuel cell stack or an electrolyzer, it is therefore necessary to stack bipolar plates correctly, that is to say to align them correctly along the stacking axis.

### SUMMARY OF THE INVENTION

In certain embodiments, the present invention aims to effectively overcome these drawbacks by proposing a bipolar plate for a fuel cell stack or for an electrolyzer stack, the bipolar plate having an anode plate and a cathode plate which are joined to one another face-to-face, the face of the anode plate that faces the face of the cathode plate delimiting an internal space that forms a circuit for the distribution of a first fluid, the anode plate and the cathode plate having distinct dimensions such that at least part of the peripheral end of the anode plate and at least part of the peripheral end of the cathode plate are offset in relation to one another in the plane of the bipolar plate, forming a shoulder at a peripheral end of the bipolar plate.

Such a configuration makes it possible to ensure proper guidance of the bipolar plates during the manufacture of a stack and to prevent any formation of a short circuit between the anode plates and the cathode plates.

According to one embodiment, the respective dimensions of the anode plate and of the cathode plate are disposed such that, at least over part of the peripheral end of the bipolar plate, the peripheral end of the cathode plate and the peripheral end of the anode plate do not face one another.

According to one embodiment, the shoulder is considered perpendicularly to the plane of the bipolar plate. In other words, the shoulder extends on the edge of the bipolar plate over its thickness.

According to one embodiment, the peripheral end of the anode plate and the peripheral end of the cathode plate each have a straight edge extending perpendicularly to the plane of the bipolar plate.

According to one embodiment, the shoulder forms a step or a crenelation.

According to one embodiment, the bipolar plate has at least one guide zone for guiding the bipolar plate during the manufacture of a stack, the guide zone being disposed at the shoulder, the guide zone including an outer edge of the bipolar plate.

According to one embodiment, the shoulder extends over at least 90% of the perimeter of the peripheral end of the bipolar plate.

According to one embodiment, the shoulder comprises an obtuse angle, notably of between 92° and 100°.

According to one embodiment, the anode plate has a first opening and the cathode plate has a second opening, the first opening and the second opening facing one another so as to form a collector for allowing the passage of the first fluid or a second fluid through the bipolar plate, the first opening and the second opening having distinct dimensions such that at least part of the peripheral end of the first opening and at least part of the peripheral end of the second opening are offset in relation to one another in the plane of the bipolar plate, forming a second shoulder at the peripheral end of the collector.

According to one embodiment, the second shoulder is considered perpendicularly to the plane of the bipolar plate.

According to one embodiment, the first fluid is a cooling fluid.

According to one embodiment, the second fluid is a fuel or an oxidant.

According to one embodiment, the anode plate is produced by molding and at least one of its edges comprises a first rake angle, the first rake angle being separate from the shoulder.

According to one embodiment, the cathode plate is produced by molding and at least one of its edges comprises a second rake angle, the second rake angle being separate from the shoulder.

The invention moreover comprises a cell for a fuel cell stack or an electrolyzer, having two bipolar plates as described above, wherein the bipolar plates sandwich a membrane electrode assembly.

According to one embodiment, the membrane electrode assembly has dimensions which make it possible to align the peripheral end of the membrane electrode assembly and the peripheral end of that one of the anode plate and the cathode plate that is furthest away from the internal space, at the shoulder.

According to one embodiment, the bipolar plate has a portion of the peripheral end which does not have a shoulder, the membrane electrode assembly projecting from the peripheral end of the bipolar plate in this portion by protruding beyond the bipolar plate in the direction of the plane of the bipolar plate.

The invention also relates to a fuel cell stack or electrolyzer, notably with a proton exchange membrane, having a stack of cells as described above.

### BRIEF DESCRIPTION OF THE DRAWINGS

The invention will be understood better from reading the following description and from studying the accompanying figures. These figures are given only by way of illustration and do not in any way limit the invention.

FIG. 1 is a schematic representation of a cell of the prior art;

FIG. 2 is a representation along the axis II-II of the cell of FIG. 1;

FIG. 3 is a schematic representation, in elevation, of a bipolar plate according to the invention;

FIG. 4 is a schematic representation, in section, of a cell according to the invention; and

FIG. 5 is a schematic representation, in section, of another embodiment of the cell according to the invention.

### DETAILED DESCRIPTION OF THE INVENTION

Those elements which are identical, similar or analogous keep the same reference from one figure to the next.

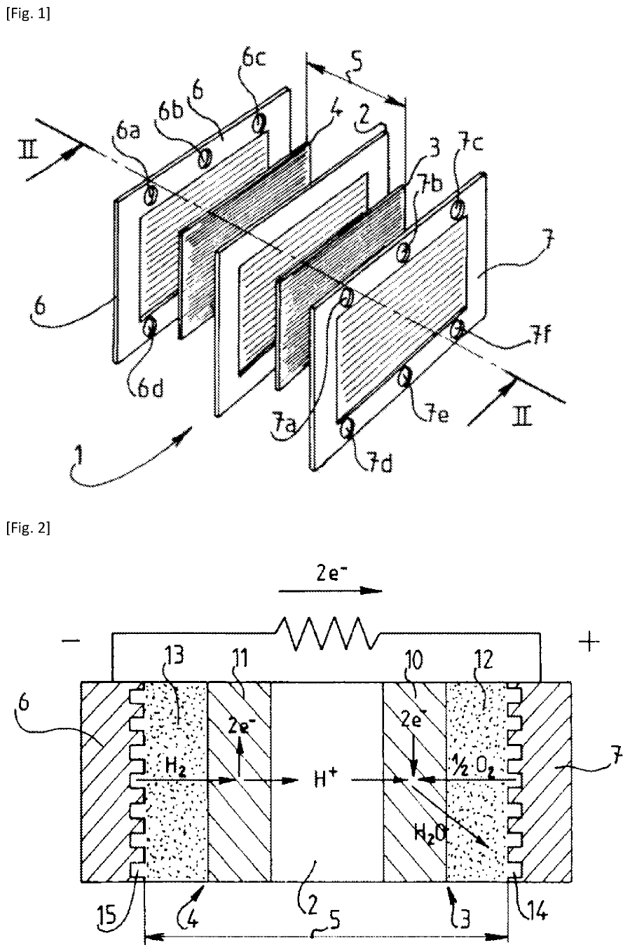

With reference to FIG. 1, which shows a cell 1 for a fuel cell stack of the prior art, it is possible to observe that such a cell 1 has a proton-conducting electrolyte 2 which is sandwiched between two porous electrodes, cathode 3 and anode 4, and ensures the transfer of protons between these two electrodes 3, 4.

To this end, the electrolyte 2 may be a polymer proton exchange membrane in particular with a thickness of between 5 and 200 μm, the resulting stack being a PEM (for “proton exchange membrane”) or PEMFC (for “proton exchange membrane fuel cell”) stack.

The assembly made up of the electrolyte 2 and the two electrodes 3, 4 forms a membrane electrode assembly (MEA) 5 which is itself sandwiched between first 6 and second 7 bipolar plates which collect current, distribute the oxidant and the fuel to the electrodes 3, 4 and circulate heat transfer fluid.

The bipolar plates 6, 7 that are typically used are made of materials that provide good corrosion resistance and electrical conductivity properties, like carbon-based materials such as graphite, polymer-impregnated graphite or flexible graphite sheets shaped by machining or by molding.

It is also possible, to produce the bipolar plates 6, 7, to use metal materials such as alloys based on titanium, on aluminum and on iron, including stainless steels. In this case, the bipolar plate 6, 7 may be shaped by pressing or stamping sheets of low thickness.

In order to ensure the distribution of the oxidant, the fuel and the heat transfer fluid in all the constituent cells of the stack, the second bipolar plate 7 has six openings 7a-7f.

The first bipolar plate 6 has the same openings disposed in the same places as on the bipolar plate 7, with FIG. 1 showing only four openings 6a-6d.

The openings 6a-6d in the first bipolar plate 6 and the openings 7a-7f in the second bipolar plate 7 are aligned so as to form collectors ensuring the circulation of fluids through all the constituent cells of the stack.

At each of these openings 7a-7f, 6a-6d, a duct, which is not shown, makes it possible to supply them with or collect the heat transfer fluid, the fuel or the oxidant circulating on the surface of the plate 6, 7 or in the plate 6, 7 or in the fluid circulation channels provided to that end.

With reference to FIG. 2, which is a section along the line II-II in FIG. 1, the cathode 3 and anode 4 electrodes each have a respective active layer 10, 11, which are where the cathode and anode reactions, respectively, take place, and a respective diffusion layer 12, 13 interposed between the active layer 10, 11 and the corresponding bipolar plate 6, 7, it being possible for this diffusion layer 12, 13 to be for example a paper substrate or a carbon cloth.

The diffusion layer 12, 13 ensures the diffusion of the reactants, such as the dihydrogen and dioxygen which circulate in the respective channels 14, 15 formed by grooves made in the respective bipolar plates 6, 7.

In this way, the active layer 11 of the anode electrode 4 is supplied with dihydrogen via the diffusion layer 13 and the reaction that takes place in this active layer 11 is as follows: H₂→2e⁻+2H⁺. In the same way, the active layer 10 of the cathode electrode 3 is supplied with oxygen via the diffusion layer 12 and the reaction that takes place in this active layer 10 is as follows: ½ O₂+2H⁺+2e⁻→H₂O. These reactions are made possible by the presence of the membrane 2 which ensures the transfer of protons from the active layer 11 of the anode 4 to the active layer 10 of the cathode 3.

In a manner known per se, a fuel cell stack or electrolyzer stack has a stack of cells 1, a first end plate and a second end plate, the stack of cells 1 being mounted between the first and second end plates.

A fuel cell stack according to the invention has a stack of cells 1 as described above. The cells 1 ensure collection of the current, distribution of the oxidant and the fuel to the electrodes, and circulation of the heat transfer fluid.

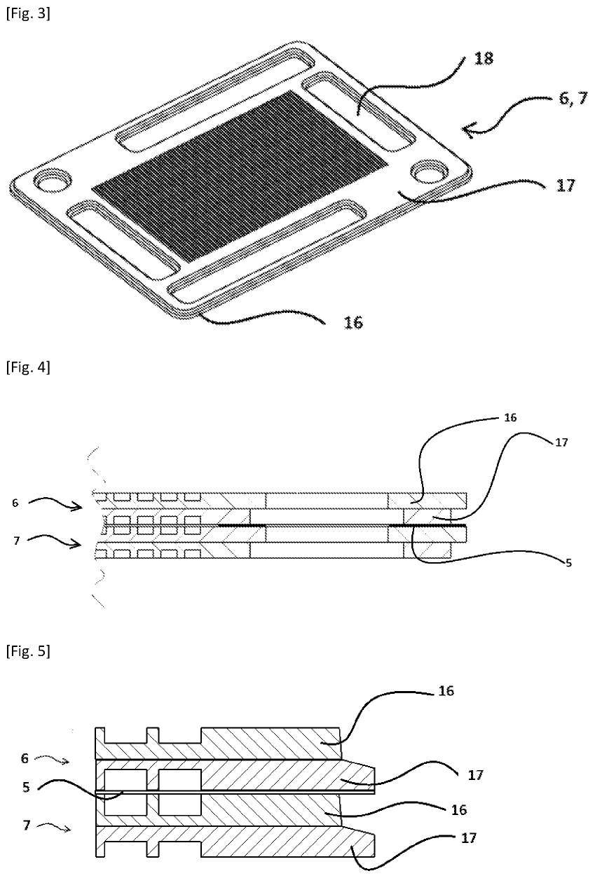

With reference to FIG. 3, the bipolar plate 6, 7 has an anode plate 16 and a cathode plate 17 that are adhesively bonded or welded face-to-face with delimitation of an internal space that forms a circuit for the distribution of a first fluid. The anode plate 16 and the cathode plate 17 each have a rectangular shape in cross section (in the thickness, the edge is straight, that is to say that it extends along a direction perpendicular to the plane of the plate).

That face of the anode plate 16 that faces the face of the cathode plate 17 has distinct dimensions such that at least part of the peripheral end of the anode plate 16 and at least part of the peripheral end of the cathode plate 17 are offset in relation to one another in the plane of the bipolar plate 6, 7, forming a shoulder at a peripheral end of the bipolar plate 6, 7, the shoulder being considered perpendicularly to the plane of the bipolar plate 6, 7.

In other words, over at least one portion of the end of the bipolar plate 6, 7, the anode plate 16 or the cathode plate 17 protrudes beyond the other.

The shoulder forms a step or crenelation.

The bipolar plate 6, 7 has a guide zone for guiding the bipolar plate 6, 7 during the manufacture of a stack, the guide zone being disposed at the shoulder, the guide zone including an outer edge of the bipolar plate. The guide zone is thus that portion of the end of the anode plate 16 or of the cathode plate 17 that protrudes beyond the other.

In the example of FIG. 3, the shoulder extends over the entire perimeter of the peripheral end of the bipolar plate 6, 7. In other words, the shoulder is continuous over the entire periphery of the bipolar plate 6, 7. As a result, the guidance can be effected over any portion of the perimeter of the plate.

In the example of FIG. 3, the anode plate 16 has a first opening for the inflow or outflow of a second fluid, the cathode plate 17 having a second opening for the inflow or outflow of the second fluid, the first opening and the second opening facing one another so as to form a collector 18 for allowing the passage of the second fluid through the bipolar plate 6, 7. The first opening and the second opening have distinct dimensions such that at least part of the peripheral end of the first opening and at least part of the peripheral end of the second opening are offset in relation to one another in the plane of the bipolar plate 6, 7, forming a second shoulder at the peripheral end of the collector 18, the second shoulder being considered perpendicularly to the plane of the bipolar plate 6, 7.

In the example of FIG. 3, all the outer edges of the bipolar plate 6, 7 (the peripheral ends of the plate 6, 7 and the peripheral ends of the collectors 18) have a shoulder and each shoulder is continuous over the entire perimeter of the edge in question.

FIG. 4 shows a cell 1 for a fuel cell stack or an electrolyzer, having two bipolar plates 6, 7 as described above in conjunction with FIG. 3, wherein the bipolar plates 6, 7 sandwich a membrane electrode assembly 5.

The membrane electrode assembly 5 has dimensions which make it possible to align the peripheral end of the membrane electrode assembly 5 and the peripheral end of that one of the anode plate 16 and the cathode plate 17 that is furthest away from the internal space, at the shoulder. In the example in question, the MEA 5 and the anode plate 16 are aligned edge-to-edge at the shoulder.

As a result, the guide zones, at the shoulder, are realized by those peripheral edges of the anode plates 16 that project beyond the cathode plates 17. It is possible to perform assembly in the reverse configuration, in which the MEA 5 is aligned edge-to-edge with the cathode plate 17.

FIG. 5 shows a cell 1 for a fuel cell stack or an electrolyzer according to another embodiment. The difference in relation to the cell 1 of FIG. 4 is that, in this embodiment, the anode plate 16 is produced by molding. The terminal edge of the first opening in the anode plate 16 comprises a first rake angle. In the example in FIG. 5, the rake angle is located in the thickness of the plate.

The cathode plate 17 is also produced by molding. The terminal edge of the second opening in the cathode plate 17 comprises a second rake angle. The second rake angle is located in the plane of the cathode plate 17.

In the example in FIG. 5, the shoulder comprises at least one obtuse angle owing to the rake angles. In the example in question, the shoulder comprises an angle of between 92° and 100°.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. A bipolar plate (6, 7) for a fuel cell stack or for an electrolyzer stack, the bipolar plate (6, 7) having an anode plate (16) and a cathode plate (17) which are joined to one another face-to-face, the face of the anode plate (16) that faces the face of the cathode plate (17) delimiting an internal space that forms a circuit for the distribution of a first fluid, the anode plate (16) and the cathode plate (17) having distinct dimensions such that at least part of the peripheral end of the anode plate (16) and at least part of the peripheral end of the cathode plate (17) are offset in relation to one another in the plane of the bipolar plate (6, 7), forming a shoulder at a peripheral end of the bipolar plate (6, 7).

2. The bipolar plate (6, 7) as claimed in the preceding claim, the peripheral end of the anode plate (16) and the peripheral end of the cathode plate each having a straight edge extending perpendicularly to the plane of the bipolar plate.

3. The bipolar plate (6, 7) as claimed in either of the preceding claims, the shoulder forming a step or a crenelation.

4. The bipolar plate (6, 7) as claimed in one of the preceding claims, having at least one guide zone for guiding the bipolar plate (6, 7) during the manufacture of a stack, the guide zone being disposed at the shoulder, the guide zone including an outer edge of the bipolar plate (6, 7).

5. The bipolar plate (6, 7) as claimed in one of the preceding claims, the shoulder extending over at least 90% of the perimeter of the peripheral end of the bipolar plate (6, 7).

6. The bipolar plate (6, 7) as claimed in one of the preceding claims, the anode plate (16) having a first opening, the cathode plate (17) having a second opening, the first opening and the second opening facing one another so as to form a collector (18) for allowing the passage of the first fluid or a second fluid through the bipolar plate (6, 7), the first opening and the second opening having distinct dimensions such that at least part of the peripheral end of the first opening and at least part of the peripheral end of the second opening are offset in relation to one another in the plane of the bipolar plate (6, 7), forming a second shoulder at the peripheral end of the collector (18).

7. A cell (1) for a fuel cell stack or an electrolyzer, having two bipolar plates (6, 7) as claimed in any one of the preceding claims, wherein the bipolar plates (6, 7) sandwich a membrane electrode assembly (5).

8. The cell (1) as claimed in the preceding claim, the membrane electrode assembly (5) having dimensions which make it possible to align the peripheral end of the membrane electrode assembly (5) and the peripheral end of that one of the anode plate (16) and the cathode plate (17) that is furthest away from the internal space, at the shoulder.

9. The cell (1) as claimed in either of claims 7 and 8, the bipolar plate (6, 7) having a portion of the peripheral end which does not have a shoulder, the membrane electrode assembly (5) projecting from the peripheral end of the bipolar plate (6, 7) in this portion by protruding beyond the bipolar plate (6, 7) in the direction of the plane of the bipolar plate (6, 7).

10. A fuel cell stack or electrolyzer, notably with a proton exchange membrane, having a stack of cells (1) as claimed in one of claims 7 to 9.
